(19) United States
(12) Patent Application Publication
(10) Pub. No.: US 2024/0159918 A1
(43) Pub. Date: May 16, 2024

(54) DOSIMETRY SYSTEM FOR MONITORING ELECTRONICS RADIATION EXPOSURE

(71) Applicant: Honeywell Federal Manufacturing & Technologies, LLC, Kansas City, MO (US)

(72) Inventors: John Porter, Kansas City, MO (US); Amir Bahadori, Manhattan, KS (US); Walter McNeil, Manhattan, KS (US); Michael Pfeifer, Manhattan, KS (US); Nathanael Simerl, Manhattan, KS (US)

(21) Appl. No.: 18/508,816

(22) Filed: Nov. 14, 2023

Related U.S. Application Data
(60) Provisional application No. 63/425,498, filed on Nov. 15, 2022.

(51) Int. Cl. G01T 1/02

(52) U.S. Cl. CPC G01T 1/026

(57) ABSTRACT

A dosimetry system for monitoring radiation exposure for a device under inspection comprises a support structure, a plurality of detectors, a signal processing unit, and a computing device. The support structure includes an upper surface on which the device under inspection is positioned. The detectors are positioned in proximity to the device under inspection. Each detector is configured to detect radiation and generate a radiation electronic signal whose level varies according to an amount of radiation to which the detector is exposed. The signal processing unit is configured to receive the radiation electronic signal from each detector and output data derived from the radiation electronic signals. The computing device is configured to receive the data from the signal processing unit and determine an accumulated radiation level for each detector.

### CROSS-REFERENCE TO RELATED APPLICATIONS

The current patent application is a non-provisional utility patent application which claims priority benefit, with regard to all common subject matter, of earlier-filed U.S. Provisional Application Ser. No. 63/425,498; titled “DOSIMETRY SYSTEM FOR MONITORING ELECTRONICS RADIATION EXPOSURE”; and filed Nov. 15, 2022. The Provisional application is hereby incorporated by reference, in its entirety, into the current patent application.

### STATEMENT REGARDING FEDERALLY-SPONSORED RESEARCH OR DEVELOPMENT

This invention was made with Government support under Contract No.: DE-NA0002839 awarded by the United States Department of Energy/National Nuclear Security Administration. The Government has certain rights in the invention.

### FIELD OF THE INVENTION

Embodiments of the current invention relate to dosimeter systems that monitor electronics which receive radiation during testing.

### DESCRIPTION OF THE RELATED ART

Highly integrated electronic circuitry is often packaged in a dense configuration with area pads, such as a pin grid array (PGA) package, a ball grid array (BGA) package, or the like, that is connected using solder reflow to a printed circuit board which may have multiple conductive layers. Given that most of the electrical connections are hidden from sight, optical inspection to discover manufacturing and assembly issues, such as solder defects and voids, does not provide useful results. Instead, X-ray inspection is utilized to detect potential problems. The X-ray inspection typically involves generating X-rays from a source that is positioned on one side of the printed circuit board and receiving the X-rays which passed through the printed circuit board with a detector that is positioned on the other side of the printed circuit board. While this approach provides good inspection capabilities, there is a maximum amount of X-ray radiation that the electronic circuitry can receive before damage occurs. And if multiple inspections are performed, care must be taken not to overexpose the electronic circuitry.

### SUMMARY OF THE INVENTION

Embodiments of the current invention address one or more of the above-mentioned problems and provide a dosimetry system for monitoring radiation exposure for a device under inspection which provides an indication of accumulated radiation levels so that the inspection can be halted before damage to the device under inspection occurs. The dosimetry system broadly comprises a support structure, a plurality of detectors, a signal processing unit, and a computing device. The support structure includes an upper surface on which the device under inspection is positioned. The detectors are positioned in proximity to the device under inspection. Each detector is configured to detect radiation and generate a radiation electronic signal whose level varies according to an amount of radiation to which the detector is exposed. The signal processing unit is configured to receive the radiation electronic signal from each detector and output data derived from the radiation electronic signals. The computing device is configured to receive the data from the signal processing unit and determine an accumulated radiation level for each detector.

Another embodiment of the current invention provides a dosimetry system for monitoring radiation exposure for a device under inspection. The dosimetry system comprises a support structure, a plurality of detectors, a signal processing unit, and a computing device. The support structure includes an upper surface on which the device under inspection is positioned. The detectors are positioned in proximity to the device under inspection. Each detector is configured to detect radiation and generate a radiation electronic signal whose level varies according to an amount of radiation to which the detector is exposed. The signal processing unit is configured to receive the radiation electronic signal from each detector. The signal processing unit includes a plurality of the following combination of components, with a successive one of the combinations configured to process each radiation electronic signal. The components include an amplifier, a filter, and an analog to digital converter. The amplifier is configured to amplify the radiation electronic signal and output an amplified radiation electronic signal. The filter is configured to filter noise from the amplified radiation electronic signal and output a filtered amplified radiation electronic signal. The analog to digital converter is configured to sample the filtered amplified radiation electronic signal on a periodic basis, and output a series or stream of radiation digital binary data values, with each digital binary data value being associated with and proportional to a successive sample of the filtered amplified radiation electronic signal. The signal processing unit further includes a microcontroller configured to receive the radiation digital binary data values from each analog to digital converter and output a serial data signal which includes the radiation digital binary data values from each analog to digital converter. The computing device is configured to receive the serial data signal from the signal processing unit and determine an accumulated radiation level for each detector.

Yet another embodiment of the current invention provides a dosimetry system for monitoring radiation exposure for a device under inspection. The dosimetry system comprises a support structure, a plurality of detectors, a signal processing unit, and a computing device. The support structure includes an upper surface on which the device under inspection is positioned. The detectors are positioned in proximity to the device under inspection. Each detector is configured to detect radiation and generate a radiation electronic signal whose level varies according to an amount of radiation to which the detector is exposed. The signal processing unit is configured to receive the radiation electronic signal from each detector. The signal processing unit includes a plurality of the following combination of components, with a successive one of the combinations configured to process each radiation electronic signal. The components include an amplifier, a filter, and an analog to digital converter. The amplifier is configured to amplify the radiation electronic signal and output an amplified radiation electronic signal. The filter is configured to filter noise from the amplified radiation electronic signal and output a filtered amplified radiation electronic signal. The analog to digital converter is configured to sample the filtered amplified radiation electronic signal on a periodic basis, and output a series or stream of radiation digital binary data values, with each digital binary data value being associated with and proportional to a successive sample of the filtered amplified radiation electronic signal. The signal processing unit further includes a microcontroller configured to receive the radiation digital binary data values from each analog to digital converter and output a serial data signal which includes the radiation digital binary data values from each analog to digital converter. The computing device is configured to receive the serial data signal from the signal processing unit, determine an accumulated radiation level for each detector, control operation of an X-ray source configured generate X-ray radiation which is detected by the detectors, and stop the generation of X-ray radiation if the accumulated radiation level from one or more of the detectors exceeds a threshold.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF THE DRAWING FIGURES

Embodiments of the current invention are described in detail below with reference to the attached drawing figures, wherein:

FIG. 1 is a schematic side view of a dosimetry system, constructed in accordance with various embodiments of the current invention, the dosimetry system being utilized with an X-ray source and an X-ray receiver in a first configuration for monitoring radiation exposure for a device under inspection;

FIG. 2 is a schematic top view of the dosimetry system;

FIG. 3 is a schematic block diagram of a signal processing unit of the dosimetry system;

FIG. 4 is a plot of a percentage maximum radiation per component vs. component number for the device under inspection; and

FIG. 5 is a schematic side view of the dosimetry system being utilized with the X-ray source and the X-ray receiver in a second configuration.

The drawing figures do not limit the current invention to the specific embodiments disclosed and described herein. The drawings are not necessarily to scale, emphasis instead being placed upon clearly illustrating the principles of the invention.

### DETAILED DESCRIPTION OF THE EMBODIMENTS

The following detailed description of the technology references the accompanying drawings that illustrate specific embodiments in which the technology can be practiced. The embodiments are intended to describe aspects of the technology in sufficient detail to enable those skilled in the art to practice the technology. Other embodiments can be utilized and changes can be made without departing from the scope of the current invention. The following detailed description is, therefore, not to be taken in a limiting sense. The scope of the current invention is defined only by the appended claims, along with the full scope of equivalents to which such claims are entitled.

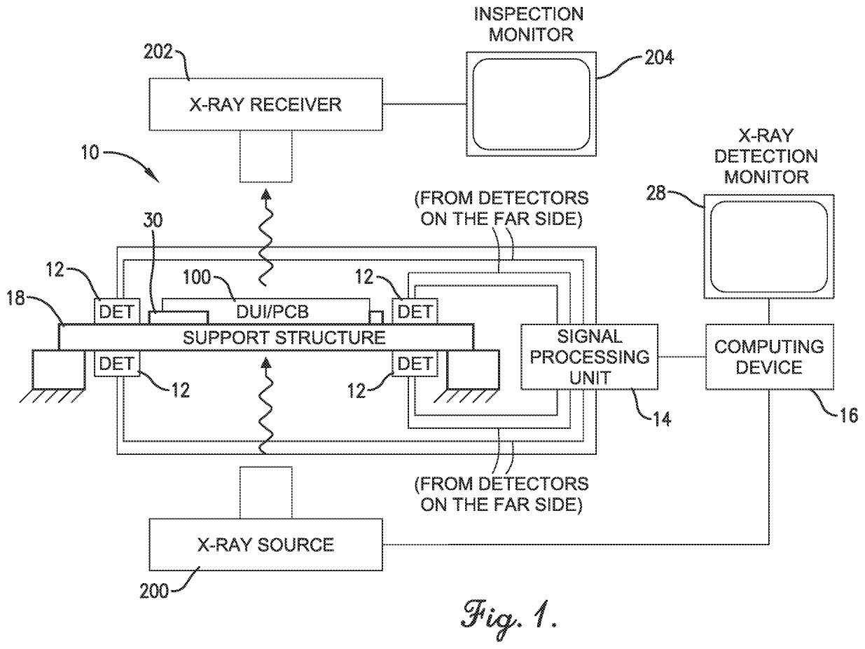

Referring to FIGS. 1, 2, and 5, a dosimetry system 10, constructed in accordance with various embodiments of the current invention, for monitoring radiation exposure for a device under inspection (DUI) 100 is shown. The DUI 100 may include, for example, a printed circuit board (PCB) with one or more components and/or dense packages, such as BGA, PGA, etc., connected to it. The DUI 100 may also include flexible circuit boards or other advanced packaging technologies. The dosimetry system 10 broadly comprises a plurality of detectors 12, a signal processing unit 14, and a computing device 16. The dosimetry system 10 may further include, be integrated with, or be operable with, a support structure 18. The dosimetry system 10 is utilized with an X-ray source 200 and an X-ray receiver 202.

The printed circuit board generally provides electrical connection between integrated circuit packages, active and passive components, connectors, and so forth. The printed circuit board may be of generally known construction with a first side and an opposing second side. The printed circuit board may also include multiple electrically conductive layers with a top conductive layer placed on the first side, a bottom conductive layer placed on the second side, one or more inner conductive layers positioned between the first and second sides, and an insulating layer between each pair of adjacent conductive layers. The insulating layers may be formed from rigidized material that includes various combinations of fiberglass, woven glass, matte glass, cotton paper, phenolic cotton paper, polyester, epoxies, epoxy resins, and the like. Each electrically conductive layer may include one or more electrically conductive features, such as electronic signal traces, electric power or ground traces, one or more signal, power, or ground pads, integrated circuit package footprints, full or partial power planes, or full or partial ground planes. In addition, the electrically conductive features include passive electrical circuit components, such as resistors, capacitors, and inductors. The conductive layers may be formed from metals typically including copper, but also including nickel, aluminum, gold, silver, palladium, zinc, tin, lead, and the like. In addition, the printed circuit board may include plated through hole vias, blind vias, buried vias, and the like.

The X-ray source 200 may generate electromagnetic radiation in the X-ray band having a wavelength ranging from 10 picometers to 10 nanometers and a frequency ranging from 30×10¹⁵ hertz (Hz) to 30×10¹⁸ Hz. The X-ray source 200 may also generate electromagnetic radiation having photon energies ranging from approximately 124 electron Volts (eV) to approximately 250 kilo eV (keV), with photon energies up to 400 keV being possible. Furthermore, the X-ray source 200 generates ionizing radiation, in the form of characteristic (fluorescence) and/or Bremsstrahlung x rays, some of which is attenuated and some of which is transmitted to the X-ray receiver 202 and/or the detectors 12. The X-ray receiver 202 receives the X-rays and outputs an electronic signal that is input to an inspection monitor 204 which displays X-ray images. The X-ray images are of the DUI 100 which specifically show the physical, electrical connection between the one or more electronic components and/or packages (BGA, PGA, etc.) and the PCB so that a technician or artificial intelligence optical inspection software program can inspect the individual solder connections.

The support structure 18 generally provides physical or mechanical support and alignment of the DUI 100. The support structure 18 includes a board, a tray, or a plate that is typically quadrilateral and has a generally planar upper surface and an opposing lower surface. The DUI 100 is positioned on the upper surface for inspection. The support structure 18 may include a fixture 30 on the upper surface that aligns the DUI 100 with the X-ray source 200 and the X-ray receiver 202. In addition, support structure 18 includes jigs or other fixtures to position the detectors 12 in proximity to the DUI 100.

Each detector 12 generally detects X-ray radiation and outputs a radiation electronic signal whose electric current value varies according to the level of X-ray radiation to which the detector 12 is exposed. Typically, there is a direct linear relationship between the level of X-ray radiation to which the detector 12 is exposed and the amount of electric current output by the detector 12, such that an increase in the level of X-ray radiation leads to a proportional increase in the amount of electric current, and a decrease in the level of X-ray radiation leads to a proportional decrease in the amount of electric current.

An exemplary detector 12 is embodied by a positive-intrinsic-negative (PIN) diode formed from silicon, such as a S2506-04 silicon PIN diode manufactured by Hamamatsu Photonics K.K. of Japan. In various embodiments, the PIN diode may be mounted to a detector printed circuit board, with a structure similar to the printed circuit board described above, which includes just the PIN diode and an electrical connector to which the PIN diode is connected through conductive traces on the printed circuit board. Alternative embodiments of the detector 12 include ion chambers and/or bulk semiconductor devices not of the PIN type.

The dosimetry system 10 may further include one or more electric power/voltage supplies (not shown in the figures) which provide electric power to each detector 12, such as by providing an electric voltage to each detector 12 to bias the detector 12 and turn it on. In various embodiments, the detector 12 utilizing the PIN diode may be reversed biased.

Exemplary embodiments of the dosimetry system 10 include eight detectors 12, with each detector 12 being placed on the support structure 18 in proximity to the DUI 100. In exemplary embodiments, a successive one of the detectors 12 may be positioned in proximity to each corner of the DUI 100 on the upper surface of the support structure 18 and a successive one of the detectors 12 may be positioned on the lower surface of the support structure 18 roughly in alignment with each detector 12 on the upper surface. In utilizing detectors 12 that include PIN diodes mounted on detector printed circuit boards, each printed circuit board may be placed or attached to the support structure 18 in the locations described.

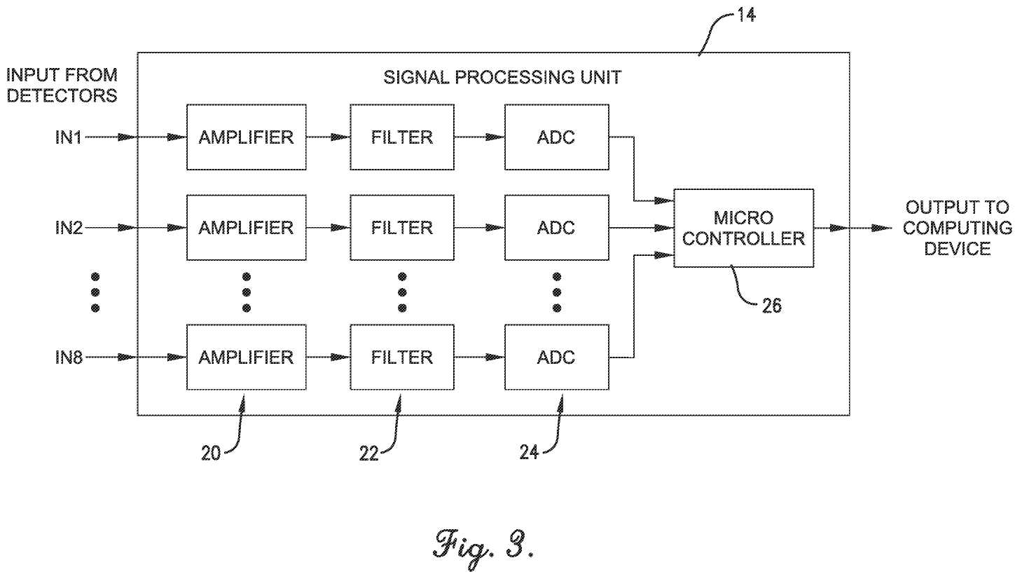

The signal processing unit 14 generally processes the radiation electronic signals from the detectors 12. An exemplary embodiment of the signal processing unit 14 includes a plurality of amplifiers 20, a plurality of filters 22, a plurality of analog to digital converters (ADC) 24, and a microcontroller 26, as shown in FIG. 3. There is a successive one of the amplifier 20, the filter 22, and the ADC 24 which form a signal chain configured to process the radiation electronic signal from each of the detectors 12. Thus, in exemplary embodiments, the signal processing unit 14 includes eight amplifiers 20, eight detectors 12, and eight ADCs 24.

The amplifier 20 may include any active amplifying electronic components, such as transistors, connected in a single stage or multi-stage architecture. The amplifier 20 is generally configured as a transimpedance amplifier. The amplifier 20 receives the radiation electronic signal, converts the current level to a voltage level, and outputs an amplified radiation electronic signal whose voltage level varies according to the current level of the radiation electronic signal, which in turn varies according to the level of X-ray radiation to which the detector 12 is exposed.

The filter 22 may include active or passive electronic devices that perform high pass, low pass, band pass, or notch filtering. The filter 22 may be utilized to filter noise from an electronic signal. The filter 22 receives the amplified radiation electronic signal output from the amplifier 20, filters noise from the signal, and outputs a filtered amplified radiation electronic signal.

The ADC 24 generally converts an analog electronic signal to a digital binary data signal. The ADC 24 includes sample and hold electronic circuitry and may utilize any one of the known types or architectures of analog to digital conversion. The ADC 24 receives the filtered amplified radiation electronic signal from the filter 22, samples the filtered amplified radiation electronic signal on a periodic basis, and outputs a series or stream of radiation digital binary data values, with each digital binary data value being associated with and proportional to a successive sample of the filtered amplified radiation electronic signal.

The microcontroller 26 generally coordinates communication of the radiation data to the computing device 16. The microcontroller 26 includes one or more central processing units or cores, memory data storage, and a plurality of inputs and outputs. The microcontroller 26 may be programmed to perform a plurality of functions. The microcontroller 26 receives the radiation digital binary data values from each ADC 24 and outputs a serial data signal which includes the radiation digital binary data values from each ADC 24. In various embodiments, the microcontroller 26 may include a code or other identifier, or may arrange or partition the radiation digital binary data values, so that each radiation digital binary data value is associated, or identifiable, with a successive one of the detectors 12. The microcontroller 26 may utilize the I²C communication bus protocol to output the radiation digital binary data values.

The above-described components of the signal processing unit 14 may be mounted on a signal processing unit printed circuit board, which has a structure similar to the printed circuit board described above. The signal processing unit printed circuit board may further include a plurality of electrical connectors, with a successive connector for each detector 12. Each electrical connector is electrically connected to a successive one of the amplifiers 20 and provides the input as shown in FIG. 3. In addition, the signal processing unit printed circuit board may include an electric power/voltage supply or may be connected to one.

The computing device 16 may be embodied by one or more high performance computers, workstation computers, desktop computers, laptop computers, palmtop computers, notebook computers, tablets or tablet computers, a single board computer such as a Raspberry Pi, and so forth. The computing device 16 may also include an X-ray detection monitor 28, which displays X-ray detection data, as described in more detail below. In addition, the computing device 16 may include a keyboard and mouse or other data entry devices, among other components which will not be discussed in detail. Furthermore, the computing device 16 includes a memory element and a processing element. The memory element may be embodied by devices or components that store data in general, and digital or binary data in particular. The processing element may include electronic hardware components such as microprocessors (single-core or multi-core), digital signal processors (DSPs), field-programmable gate arrays (FPGAs), analog and/or digital application-specific integrated circuits (ASICs), intelligence circuitry, or the like, or combinations thereof. The processing element is in electronic communication with the memory element and may be programmed or configured to perform a plurality of functions of the computing device 16 described herein.

The computing device 16 receives the serial data signal from the microcontroller 26 of the signal processing unit 14. The computing device 16 may store the radiation digital binary data values in the memory element. The computing device 16 may parse the radiation digital binary data values to determine which of the radiation digital binary data values is associated with each of the detectors 12. The computing device 16 may also convert or interpret the radiation digital binary data values to determine an actual radiation level, or amount, of each radiation digital binary data value in units of rads. Furthermore, the computing device 16 may perform an accumulation function on the radiation level over time from each detector 12 and a sum of the radiation levels from all of the detectors 12 to determine an accumulated radiation level for each detector 12 and a total accumulated radiation level which includes the sum of the accumulated radiation levels from all of the detectors 12. The computing device 16 may also determine statistical data, such as a mean or average radiation level from all of the detectors 12. In addition, the computing device 16 may apply artificial intelligence (AI) techniques or algorithms to the radiation level data to determine trends or anomalies in the data.

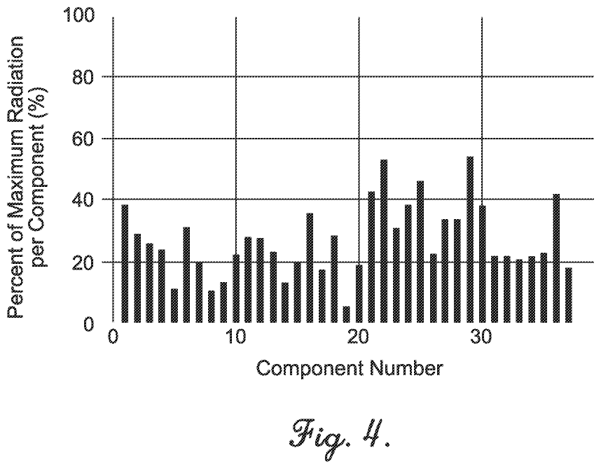

The computing device 16 may display on the X-ray detection monitor 28 a plot of the radiation level for each detector 12, or individual components or packages of the DUI 100, as the radiation levels grow overtime. In some embodiments, the computing device 16 may determine the radiation level of each detector 12, or component, as a percentage of a maximum allowable dose of radiation for the components or the DUI 100 as a whole. Referring to FIG. 4, the computing device 16 may display on the X-ray detection monitor 28 the plot of the percentage of maximum radiation per component vs. the component number. The plot as shown in FIG. 4 is a snapshot of a particular instant in time during an inspection. The percentage values for each component will change over time. Additionally, if the accumulated radiation level for any detector 12 exceeds an individual radiation threshold, or if the total accumulated radiation level exceeds a total radiation threshold, then the computing device 16 may issue a visual and/or audible warning. For example, the computing device 16 may flash a light and/or sound an alarm.

In certain embodiments, the computing device 16 is in electronic communication with the X-ray source 200 and may control its operation. For example, the computing device 16 may control the starting and stopping of the X-ray generation. In addition, the computing device 16 may control a level or intensity of the X-ray radiation being generated. Furthermore, the computing device 16, as described above, determines the accumulated radiation level for each detector 12 and the total accumulated radiation level which includes the sum of the accumulated radiation levels from all of the detectors 12 or a subset of all of the detectors 12. If the accumulated radiation level for any detector 12 exceeds an individual radiation threshold, then the computing device 16 may stop generation of the X-rays. If the total accumulated radiation level exceeds a total radiation threshold, then the computing device 16 may stop generation of the X-rays.

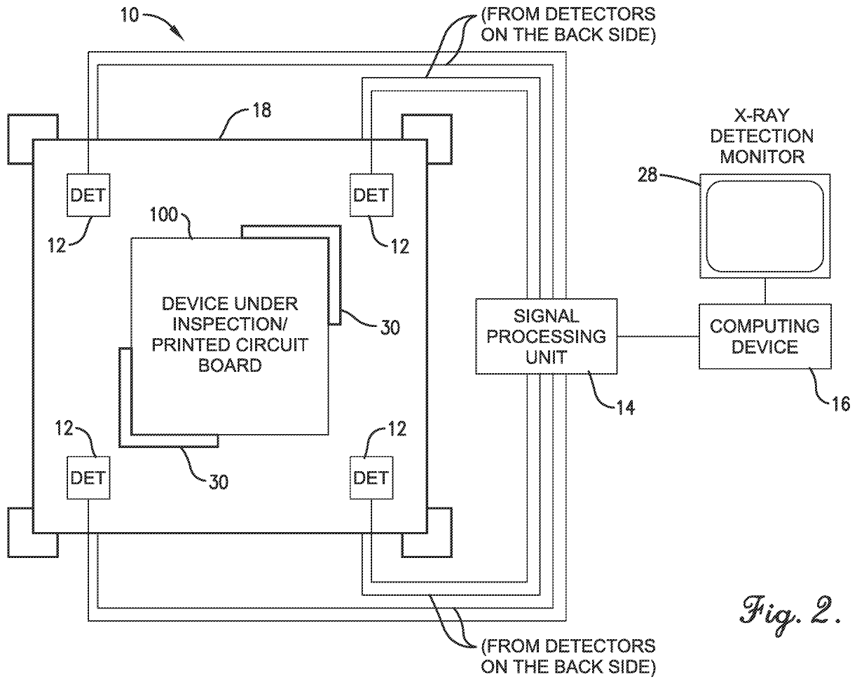

The components of the dosimetry system 10 are set up and connected as follows. The detectors 12 are positioned and attached to the support structure 18. In general, the detectors 12 may be positioned anywhere on the support structure 18 in the vicinity of the DUI 100. Exemplary embodiments include four detectors 12 positioned on the upper surface with a successive one of the detectors 12 adjacent to each corner of the DUI 100. The remaining four detectors 12 are positioned and attached to the lower surface of the support structure 18 with each detector 12 being positioned in general alignment with a successive one of the detectors 12 on the upper surface. The detectors 12 are electrically connected to the signal processing unit 14 using a plurality of conductive cables. Specifically, each detector 12 is electrically connected to its associated amplifier 20 of the signal processing unit 14 through the connector on the detector printed circuit board, a successive one of the conductive cables, and a successive one of the connectors on the signal processing unit printed circuit board. The conductive cables are typically routed away from the inspection space, which includes the DUI 100 and its surrounding area, in order to avoid shielding the detectors 12 from the X-ray radiation. Thus, the conductive cables may be positioned along the edge of the support structure 18 or off of the support structure 18, as shown in FIG. 2.

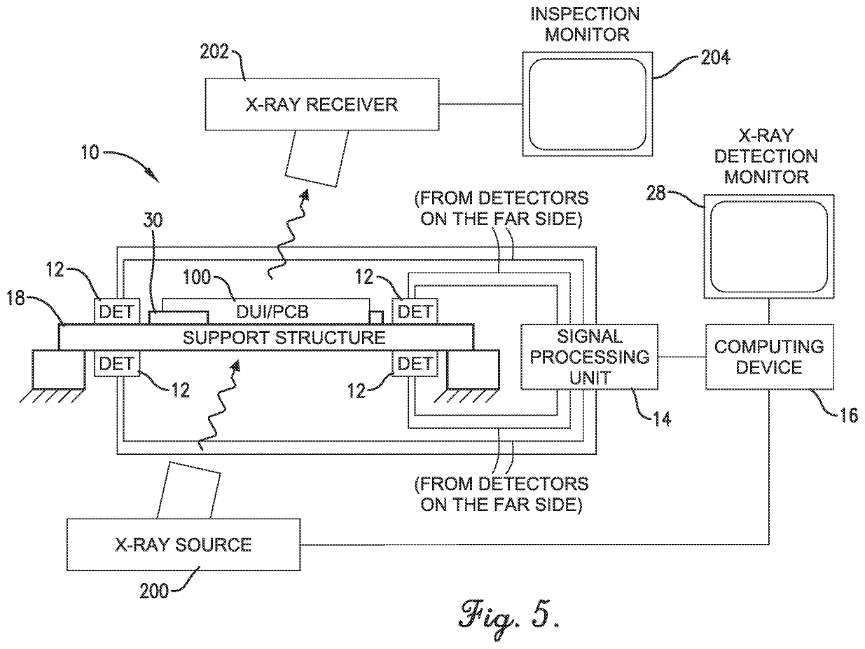

The DUI 100 is placed in the fixture 30 on the upper surface of the support structure 18. For a first portion of the inspection, the X-ray source 200 is positioned beneath the support structure 18 roughly in line with a center axis of the DUI 100 in a direct configuration, as shown in FIG. 1. The X-ray receiver 202 is positioned above the support structure 18 roughly in line with the center axis of the DUI 100. For a second portion of the inspection, the X-ray source 200 is positioned beneath the support structure 18 at a non-zero distance away from the center axis of the DUI 100 in an offset configuration, as shown in FIG. 5. The X-ray source 200 is oriented such that it aims a beam of X rays at the center of the DUI 100. The X-ray receiver 202 is positioned above the support structure 18 at a non-zero distance away from the center axis of the DUI 100 in a direction opposite from the X-ray source 200. The X-ray receiver 202 is oriented such that it receives the beam of X rays from the center of the DUI 100.

The dosimetry system 10 may operate as follows. The X-ray source 200 is positioned in the direct configuration, as shown in FIG. 1. The X-ray source 200 may be activated to generate X-ray radiation either manually by a technician or operator or automatically by the computing device 16. The X-ray images of the DUI 100 are shown on the inspection monitor 204 so that the technician or artificial intelligence optical inspection software program can inspect the individual solder connections of the area pad electronic packages.

While the X-ray source 200 is generating X-ray radiation, the detectors 12 detect the level of radiation in the DUI 100 and its surroundings. In response to receiving radiation, each detector 12 generates the radiation electronic signal that includes electric current which varies according to the level of radiation in a direct, linear fashion. That is, an increase in the level of X-ray radiation leads to a proportional increase in the amount of electric current, and a decrease in the level of X-ray radiation leads to a proportional decrease in the amount of electric current. The radiation electronic signal from each detector 12 is processed by the signal processing unit 14, where the signal is amplified, filtered, sampled, and converted to a radiation digital binary data value. The signal processing unit 14 outputs a stream or sequence of radiation digital binary data values which includes the ongoing radiation digital binary data values from each detector 12.

The computing device 16 receives the stream of radiation digital binary data values and converts or interprets the radiation digital binary data values to determine an actual radiation level, or amount, of each radiation digital binary data value in units of rads. The computing device 16 also displays on the X-ray detection monitor 28 data regarding the radiation levels detected by the detectors 12. For example, the computing device 16 displays on the X-ray detection monitor 28 a plot of the percentage of maximum radiation per component of the DUI 100 vs. the component number, as shown in FIG. 4. The plot may include the accumulated radiation level over time for each component. From this, the technician can monitor the radiation levels received by the DUI 100. As the radiation level of one or more components reaches 100%, or any other threshold, the technician can stop the X-ray source 200 from generating X rays. In some embodiments, the technician may stop the X-ray source 200 from generating X rays when the radiation level of any one of the components (or detectors 12) reaches 50%, or any other threshold, so that the technician can then reposition or orient the X-ray source 200 and the X-ray receiver 202 in the offset configuration, as shown in FIG. 5. The technician or the computing device 16 restarts the X-ray source 200 while the computing device 16 again displays the radiation level data. Once the radiation level reaches a certain threshold, the technician may stop the X-ray source 200.

In certain embodiments, the computing device 16 monitors the accumulated radiation levels from the detectors 12 during the inspection using the direct configuration or the offset configuration. If the accumulated radiation level from any one detector 12 or the sum of accumulated radiation levels from all of the detectors 12 or a subset of the detectors 12 exceeds a certain threshold, then the computing device 16 stops the X-ray source 200 from generating X rays.

### Additional Considerations

Throughout this specification, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current invention can include a variety of combinations and/or integrations of the embodiments described herein.

Although the present application sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processing element, may be implemented as special purpose or as general purpose. For example, the processing element may comprise dedicated circuitry or logic that is permanently configured, such as an application-specific integrated circuit (ASIC), or indefinitely configured, such as an FPGA, to perform certain operations. The processing element may also comprise programmable logic or circuitry (e.g., as encompassed within a general-purpose processor or other programmable processor) that is temporarily configured by software to perform certain operations. It will be appreciated that the decision to implement the processing element as special purpose, in dedicated and permanently configured circuitry, or as general purpose (e.g., configured by software) may be driven by cost and time considerations.

Accordingly, the term “processing element” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processing element is temporarily configured (e.g., programmed), each of the processing elements need not be configured or instantiated at any one instance in time. For example, where the processing element comprises a general-purpose processor configured using software, the general-purpose processor may be configured as respective different processing elements at different times. Software may accordingly configure the processing element to constitute a particular hardware configuration at one instance of time and to constitute a different hardware configuration at a different instance of time.

Computer hardware components, such as communication elements, memory elements, processing elements, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processing elements that are temporarily configured (e.g., by software) or permanently configured to perform the relevant operations. Whether temporarily or permanently configured, such processing elements may constitute processing element-implemented modules that operate to perform one or more operations or functions. The modules referred to herein may, in some example embodiments, comprise processing element-implemented modules.

Similarly, the methods or routines described herein may be at least partially processing element-implemented. For example, at least some of the operations of a method may be performed by one or more processing elements or processing element-implemented hardware modules. The performance of certain of the operations may be distributed among the one or more processing elements, not only residing within a single machine, but deployed across a number of machines. In some example embodiments, the processing elements may be located in a single location (e.g., within a home environment, an office environment or as a server farm), while in other embodiments the processing elements may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processing element and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claims at the end of this patent application are not intended to be construed under 35 U.S.C. § 112(f) unless traditional means-plus-function language is expressly recited, such as “means for” or “step for” language being explicitly recited in the claim(s).

Although the technology has been described with reference to the embodiments illustrated in the attached drawing figures, it is noted that equivalents may be employed and substitutions made herein without departing from the scope of the technology as recited in the claims.

Having thus described various embodiments of the technology, what is claimed as new and desired to be protected by Letters Patent includes the following:

1. A dosimetry system for monitoring radiation exposure for a device under inspection, the dosimetry system comprising:
a plurality of detectors positioned in proximity to the device under inspection, each detector configured to detect radiation and generate a radiation electronic signal whose level varies according to an amount of radiation to which the detector is exposed;
a signal processing unit configured to receive the radiation electronic signal from each detector and output data derived from the radiation electronic signals; and
a computing device configured to receive the data from the signal processing unit and determine an accumulated radiation level for each detector.

2. The dosimetry system of claim 1, wherein each detector includes a positive-intrinsic-negative (PIN) diode formed from silicon.

3. The dosimetry system of claim 2, further comprising a plurality of detector printed circuit boards, wherein each detector is mounted on a successive one of the detector printed circuit boards.

4. The dosimetry system of claim 1, further comprising a support structure including an upper surface on which the device under inspection and a first portion of the detectors adjacent to the device under inspection are positioned.

5. The dosimetry system of claim 4, wherein the support structure includes an opposing lower surface and a second portion of the detectors is positioned on the lower surface with each detector on the lower surface positioned roughly in alignment with a successive one of the detectors positioned on the upper surface.

6. The dosimetry system of claim 1, wherein the radiation electronic signal from each detector includes an electric current whose level varies according to an amount of radiation to which the detector is exposed.

7. The dosimetry system of claim 1, wherein the signal processing unit includes a plurality of the following combination of components, with a successive one of the combinations configured to process each radiation electronic signal:
an amplifier configured to amplify the radiation electronic signal and output an amplified radiation electronic signal,
a filter configured to filter noise from the amplified radiation electronic signal and output a filtered amplified radiation electronic signal, and
an analog to digital converter configured to sample the filtered amplified radiation electronic signal on a periodic basis, and output a series or stream of radiation digital binary data values, with each digital binary data value being associated with and proportional to a successive sample of the filtered amplified radiation electronic signal.

8. The dosimetry system of claim 1, wherein the signal processing unit further includes a microcontroller configured to receive the radiation digital binary data values from each analog to digital converter and output a serial data signal which includes the radiation digital binary data values from each analog to digital converter.

9. The dosimetry system of claim 1, wherein the components of the signal processing unit are mounted on a signal processing unit printed circuit board.

10. The dosimetry system of claim 1, wherein the computing device is further configured to display on a monitor a plot of accumulated radiation levels for a plurality of components of the device under inspection.

11. The dosimetry system of claim 1, wherein the computing device is further configured to
control operation of an X-ray source configured generate X-ray radiation which is detected by the detectors, and
stop the generation of X-ray radiation if the accumulated radiation level from one or more of the detectors exceeds a threshold.

12. A dosimetry system for monitoring radiation exposure for a device under inspection, the dosimetry system comprising:
a support structure including an upper surface on which the device under inspection is positioned;
a plurality of detectors positioned in proximity to the device under inspection, each detector configured to detect radiation and generate a radiation electronic signal whose level varies according to an amount of radiation to which the detector is exposed;
a signal processing unit configured to receive the radiation electronic signal from each detector, the signal processing unit including a plurality of the following combination of components, with a successive one of the combinations configured to process each radiation electronic signal:
an amplifier configured to amplify the radiation electronic signal and output an amplified radiation electronic signal,
a filter configured to filter noise from the amplified radiation electronic signal and output a filtered amplified radiation electronic signal, and
an analog to digital converter configured to sample the filtered amplified radiation electronic signal on a periodic basis, and output a series or stream of radiation digital binary data values, with each digital binary data value being associated with and proportional to a successive sample of the filtered amplified radiation electronic signal, and
the signal processing unit further including a microcontroller configured to receive the radiation digital binary data values from each analog to digital converter and output a serial data signal which includes the radiation digital binary data values from each analog to digital converter;
a computing device configured to receive the serial data signal from the signal processing unit and determine an accumulated radiation level for each detector.

13. The dosimetry system of claim 12, wherein each detector includes a positive-intrinsic-negative (PIN) diode formed from silicon.

14. The dosimetry system of claim 13, further comprising a plurality of detector printed circuit boards, wherein each detector is mounted on a successive one of the detector printed circuit boards.

15. The dosimetry system of claim 12, wherein a first portion of the detectors is positioned on the upper surface of the support structure adjacent to the device under inspection.

16. The dosimetry system of claim 15, wherein the support structure includes an opposing lower surface and a second portion of the detectors is positioned on the lower surface with each detector on the lower surface positioned roughly in alignment with a successive one of the detectors positioned on the upper surface.

17. The dosimetry system of claim 12, wherein the radiation electronic signal from each detector includes an electric current whose level varies according to an amount of radiation to which the detector is exposed.

18. The dosimetry system of claim 12, wherein the components of the signal processing unit are mounted on a signal processing unit printed circuit board.

19. The dosimetry system of claim 12, wherein the computing device is further configured to display on a monitor a plot of accumulated radiation levels for a plurality of components of the device under inspection.

20. A dosimetry system for monitoring radiation exposure for a device under inspection, the dosimetry system comprising:
a support structure including an upper surface on which the device under inspection is positioned;
a plurality of detectors positioned in proximity to the device under inspection, each detector configured to detect radiation and generate a radiation electronic signal whose level varies according to an amount of radiation to which the detector is exposed;
a signal processing unit configured to receive the radiation electronic signal from each detector, the signal processing unit including a plurality of the following combination of components, with a successive one of the combinations configured to process each radiation electronic signal:
an amplifier configured to amplify the radiation electronic signal and output an amplified radiation electronic signal,
a filter configured to filter noise from the amplified radiation electronic signal and output a filtered amplified radiation electronic signal, and
an analog to digital converter configured to sample the filtered amplified radiation electronic signal on a periodic basis, and output a series or stream of radiation digital binary data values, with each digital binary data value being associated with and proportional to a successive sample of the filtered amplified radiation electronic signal, and
the signal processing unit further including a microcontroller configured to receive the radiation digital binary data values from each analog to digital converter and output a serial data signal which includes the radiation digital binary data values from each analog to digital converter;
a computing device configured to receive the serial data signal from the signal processing unit,
determine an accumulated radiation level for each detector,
control operation of an X-ray source configured generate X-ray radiation which is detected by the detectors, and
stop the generation of X-ray radiation if the accumulated radiation level from one or more of the detectors exceeds a threshold.
